(19) United States
(12) Patent Application Publication
(10) Pub. No.: US 2022/0220248 A1
(43) Pub. Date: Jul. 14, 2022

(54) SOLVENT BORNE THERMOSET POLYAMIDE URETHANE AND/OR UREA BASED COATINGS

(71) Applicant: Lubrizol Advanced Materials, Inc., Cleveland, OH (US)

(72) Inventors: Gabor ERDODI, Macedonia, OH (US); Naser POURAHMADY, San Diego, CA (US); Israel J. SKOFF, Stow, OH (US); Amanda DECHANT, Cuyahoga Falls, OH (US); Christopher SWECH, Medina, OH (US)

(21) Appl. No.: 17/615,151

(22) PCT Filed: May 28, 2020
(86) PCT No.: PCT/US20/34772

§ 371 Date: Nov. 30, 2021

Related U.S. Application Data
(60) Provisional application No. 62/854,726, filed on May 30, 2019.

(51) Int. Cl. C08G 18/60; C08G 18/73; C08G 18/08; C08J 5/18; C09D 175/12; C09J 175/12

(52) U.S. Cl. CPC C08G 18/603; C08G 18/73; C08G 18/0852; C08J 2375/12; C09D 175/12; C09J 175/12; C08J 5/18

(57) ABSTRACT

The present invention relates to thermoset polymer solution, such as a polyurethanes and/or polyureas that include sufficient polyamide to give polyamide strength, adhesion, and durability, wherein the polymer solutions can be prepared as a one-component or two component solvent-borne coating composition. The polyamides give a harder, more chemical resistant, and often tougher thermoset, than similar water-borne polyurethanes rich in polyamide. The compositions of this disclosure differ from other polyamides as they have been formulated to be appropriate viscosity to use as coatings and then have crosslinking technology to form hard thermoset films.

### FIELD OF INVENTION

The present invention relates to polymeric systems based on hydroxyl, amine, or carboxylic acid terminated polyamide rich oligomers reacted with polyisocyanates (optionally blocked) or polyepoxides to make thermoset solvent-borne ink and coating compositions. These can be one component systems or two component systems.

### BACKGROUND OF THE INVENTION

Because of hydrogen bonding associated with the amide linkage, polyamides are normally processed in the melt stage or for some very rigid aromatic polyamide chains via a process where the chains are oriented during processing. Polyamides can have very high strength and good barrier properties.

WO 2014/126739 A1 and WO 2014/126741 A2 were filed by the same applicant and disclose telechelic N-alkylated polyamides polymers and uses of those telechelic polyamides in water-borne polyamide-urea dispersions.

### SUMMARY OF THE INVENTION

One objective was to make new improved polyamide rich crosslinkable (thermoset) polymer systems that can be used in coating compositions having higher performance levels than the earlier WO 2014/126741 A2 publication based on water-borne polyamides. Water-borne systems inherently have problems with the surface-active moieties included to facilitate forming the water-borne dispersions. The surface-active species tend to become bound into the final coating at the interfaces where the individual particles of the polyamide dispersions have tried to fuse together into a coherent barrier film. To some extent, the surface active rich phases in the final coating can decrease the final film strength and result in easier penetration of water and other polar species through the final film. Annealing the coating from the water-borne dispersions can better fuse the individual particles and can foster the migration of surface active species away from the interfaces between the particles.

It is anticipated that if a solvent-borne polyamide rich composition could be developed with low amounts of solvents and/or solvents acceptable to the coatings industry, these solvent-borne compositions would have improved mechanical and barrier properties relative to the water-borne polymer dispersions. But several inherent problems exist with making solvent-borne polyamide-rich compositions for coatings or inks. First, many common solvents are not good for polyamides. Due to hydrogen bonding, polyamides tend to be solids at room temperature and up to about 130° C. Solvents good for coatings generally evaporate quickly at 15° C. or slightly higher temperature, so that no heating is needed to convert the coating from a wet film to a dry film when using these solvents, but these solvents are difficult to incorporate in polyamides at temperatures above 100° C. As polyamides increase their molecular-weight they become less compatible with solvents.

Another objective is to prepare crosslinked polyamide rich coatings for a variety of substrates from a liquid polymer composition at room temperature (e.g., 20-25° C., preferably 24° C.) with minimal use or release of hazardous organic solvents (trying to use a minimal amount of organic solvent and those solvents most acceptable to the coatings industry and having the lowest hazard level).

It was found that dicarboxylic acids were preferred for forming the polyamide that had between 4 to 50 (optionally 10 to 50) carbon atoms and they gave more processable polyamides. Examples of dicarboxylic acids include sebacic acid and dimer fatty acids. We found it desirable to have diamines having either secondary amines end groups and/or a bent structure such that the two nitrogen atoms forming the amide linkages of the polyamide (derived from the diamine component) were rigidly positioned relative to each other and could often prevent effective or strong hydrogen bonding of amide linkages in the polyamide, or diamines with sterically bulky substituents on adjacent carbon atoms to the primary nitrogen group that can prevent the nitrogen or amide linkage from forming strong hydrogen bonds, with other amide linkages of the polyamide phase. Such diamines that disrupt hydrogen bonding near the amide bond make the resulting polyamides more processable as melts and as solvent-borne compositions. Such diamines may, for example, be selected from cyclic diamines such as piperazine, 4,4′-trimethylenepiperidine, certain diamines of phenylene, certain diamines from diphenylmethylene, etc. It was unexpected that flexibility and a single hydrocarbon chain between the carboxylic acid moieties and a double hydrocarbon chain or rings were more desirable in the diamine component to achieve a polyamide that is processable at or only slightly above 25° C.

We have developed methods of increasing the molecular weight of the polyamide rich polymers of the composition crosslinking the composition into a thermoset. We have also developed other softer polymer segments and ways to incorporate the softer polymer segments into the composition to facilitate making the otherwise hard and waxy polyamides solvent swellable into liquid coating compositions with viscosities suitable for application as coatings.

The problem of volatility of the solvents is partially solved by using blends of solvents, when necessary, to allow heating of the polyamides and solvent to temperatures where they can be blended. The volatility of the solvents is partially controlled by using very polymer rich compositions. The solvent swellable polyamide rich compositions are formulated at high polymer solids to minimize solvent recovery and release of solvent into the environment during film formation.

The following embodiments of the present subject matter are contemplated:

1. A thermosettable composition comprising:

a) 10 to 75 wt. % of a polyamide oligomer predominantly having at least two amide linkages and two terminal end groups selected from the end groups of amine, hydroxyl or carboxylic acid end groups,

b) 10 to about 40 or 50 wt. % of a di or polyisocyanate component (optionally where the isocyanate reactivity is temporarily blocked) reactive with amine, carboxylic, and/or hydroxyl groups to form covalent chemical bonds,

c) optionally one or more non-reactive organic diluents, and

d) up to 50, more desirably only up to 40 or 25 wt. %, of one or more compounds of less than 500 g/mole molecular weight (not being a polyamide) having three or more groups reactive with isocyanates selected from the group of amine and hydroxyl groups;

wherein said thermosettable composition of a), b), c) and d) prior to reaction of said isocyanate groups with said end groups selected from amine, hydroxyl, or carboxylic acid end groups, has an average functionality of all isocyanate, amine, hydroxyl, and carboxylic acid end groups of 2.1 or more per molecule;

wherein said weight percentages are based on the total components to said thermosettable composition; and

wherein said composition prior to reaction of said di or polyisocyanate, when at or diluted to 50% solids has a viscosity at 25° C. of less than 10,000 cps (more desirably less than 5,000 cps or 2,000 cps, and preferably from about 100 to 5,000 cps) measured by a Brookfield Rotating Disc viscometer, using a rotation speed of 5 rpm, and a #6 spindle.

2. The thermosettable composition of embodiment 1, wherein the polyamide oligomer is polyamide repeat units derived from polymerizing

a) diamines having two amine groups capable of forming covalent bonds with a carbonyl of a carboxylic acid selected from the group consisting of diamines having from 4 to 60 carbon atoms (optionally including one other heteroatom) having two secondary terminal amine groups and/or diamines having from 4 to 60 carbon atoms (optionally including one other heteroatom) having one or two primary amine groups, (desirably wherein the diamines having one or two primary amine groups are characterized as diamines wherein a) substituents on carbon atoms adjacent to the primary amine nitrogen block the nitrogen from forming strong hydrogen bonding with nearby amide linkages and/or the primary amine nitrogen is pendant from an aliphatic or aromatic ring structure in a position from a ring such that the primary amine nitrogen cannot form strong hydrogen bonds with nearby amide linkages), with

b) lactone and or carboxylic acid monomers, wherein the lactone or carboxylic acid units are from an acid component selected from the group consisting of C₅ to C₈ lactone C₅ to C₈ hydroxycarboxylic acids, and aliphatic dicarboxylic acids of 4 to 50 carbon atoms, wherein said lactone and/or carboxylic acid monomers form repeat units with a carbonyl from the lactone, hydroxycarboxylic acids, and aliphatic dicarboxylic acid reacting with an primary or secondary amine nitrogen to form amide linkage and thereby forming a polyamide oligomer.

3. The thermosettable composition of embodiment 2, wherein at least 40, desirably at least 50, more desirably at least 80, and preferably at least 90 mole % of said diamine are cyclic diamines where the nitrogen atoms are in secondary amine groups and part of the one or more rings and having 4 to 15 (more desirably 4 to 13) carbon atoms, such as piperazine and 4, 4′-trimethylelenedipiperidine.

4. The thermosettable composition of either embodiment 2 or embodiment 3, wherein at least 50, more desirably at least 80, and preferably at least 90 mole % of said diamines are diamines having two primary amine groups, said diamines having primary two primary amine groups being of the structures

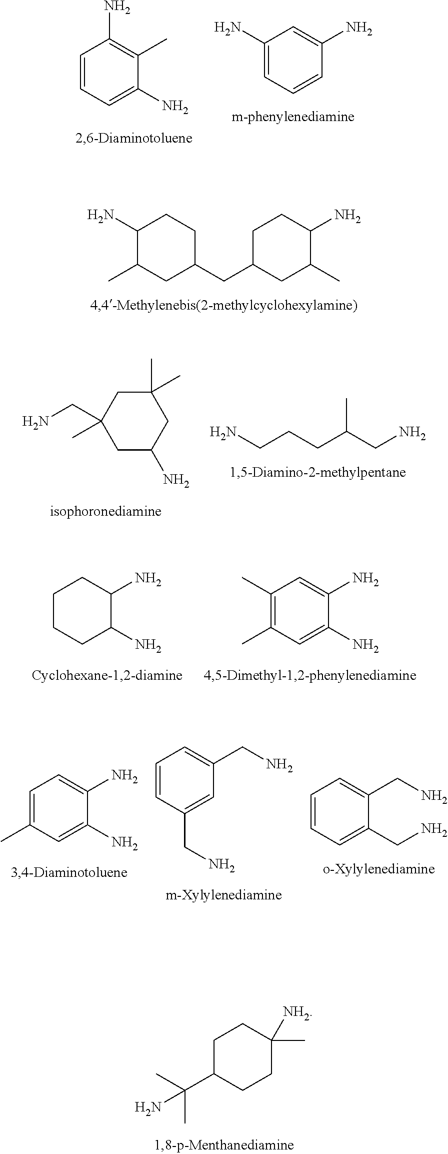

5. The thermosettable composition of any one of embodiments 2 to 4, wherein the polyamide oligomer is comprised of repeat units from dicarboxylic acids reacted with amine groups wherein at least 50, more desirably at least 80, and preferably at least 90 mole % of said dicarboxylic acid component being in an amide repeat unit are dicarboxylic acids of 10 to 50 carbon atom, more desirably 25 to 50 carbon atoms.

6. The thermosettable composition of any one of embodiments 2 to 5, wherein at least 50 wt. % (more desirably at least 60, 70, 80 or 90 wt. %) of the repeat units from carboxylic acids are derived from dimer fatty acids, optionally hydrogenated.

7. The thermosettable composition of the previous embodiments 2-6, wherein the combined repeat units of diamine and lactone and/or carboxylic acid monomers forming at least one amide linkage during their polymerization into said polyamide are from 20 to about 60 wt. % of the thermosettable composition.

8. The thermosettable composition of any one of embodiments 2 to 7, wherein the combined repeat units of diamine and lactone and/or carboxylic acid monomers forming at least one amide linkage during their polymerization into said polyamide are from 25 to about 50 wt. % of the thermosettable composition.

9. The thermosettable composition of any one of embodiments 2 to 8, wherein at least 90 wt. % of the repeat units from diamines are derived from cyclic and/or dicyclic diamines of 4 to 15 (more desirably 4 to 13) carbon atoms, wherein the nitrogen atoms of the diamine are part of the ring structure, such as piperazine or 4,4′-trimethylenepiperidine.

10. The thermosettable composition of any one of embodiments 1 to 9, wherein said reactive polyisocyanate or blocked isocyanate, combined if both are present, are present in the solution in an amount for about 10 to 50 wt. % of said solution (based on the weight of all components to said composition).

11. The thermosettable composition of any one of embodiments 1 to 10, wherein said organic diluent is present from about 10 to about 50 wt. % of said composition.

12. The thermosettable composition of embodiment 11, wherein said organic diluent is selected from the group consisting of isopropanol, acetone, dimethyl carbonate, and butyl acetate.

13. The thermosettable composition of any one of embodiments 1 to 12, wherein the solution after evaporation of the solvent is thermoset.

14. The thermosettable composition of any one of embodiments 1 to 13, or 15 to 16 (below), formed into a self-supporting film, coating, or adhesive.

15. The thermosettable composition of any one of embodiments 1 to 13, wherein said polyisocyanate component has two or more isocyanate groups per polyisocyanate and the ratio of isocyanate groups of said polyisocyanate to combined hydroxyl, amino and/or carboxylic groups is from 2:1 to 1:1.

16. The thermosettable composition of any one of embodiments 1 to 13 or 15, wherein as the organic diluent evaporates, the polyamide oligomer is crosslinked via reactions with said polyisocyanate component reactive with hydroxyl, carboxylic, and/or amino groups to form covalent chemical bonds to create a polymer of number average molecular weight of at least 1,000,000 g/mole.

17. A method for forming a thermosettable coating or film comprising:

a) polymerizing diamines selected from the group consisting of diamines having from 4 to 60 carbon atoms (optionally including one other heteroatom) and having two secondary terminal amine groups and diamines having two primary amine groups, (wherein said diamines having two primary amine groups are preferably of the structures

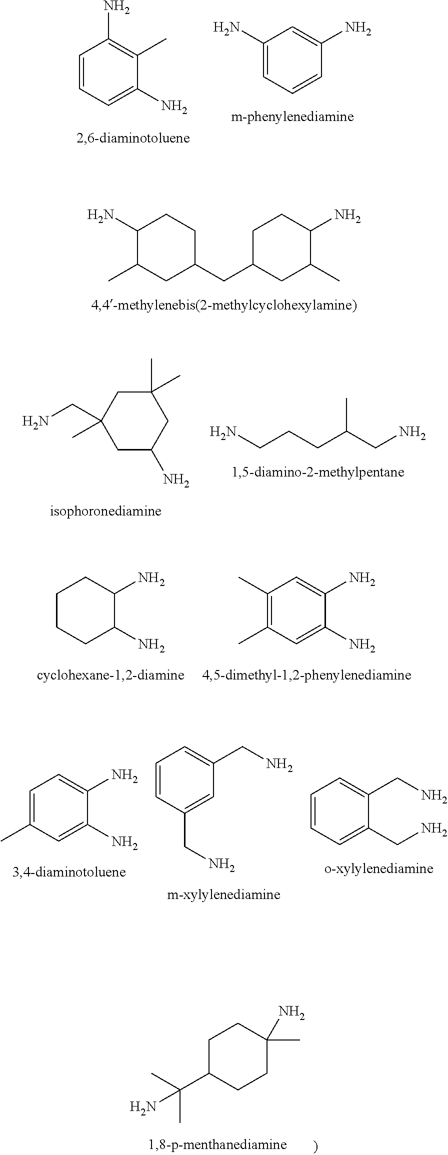

reacted with carboxylic acid groups, wherein the carboxylic acid units are from a lactone and/or carboxylic acid component selected from the group consisting of C₅ to C₈ lactone C₅ to C₈ hydroxycarboxylic acids, and aliphatic dicarboxylic acids of 4 to 50 carbon atom; forming repeat units with a carbonyl or nitrogen as part of an amide linkage and thereby forming a polyamide oligomer; and wherein said polyamide oligomer has at least two terminal groups selected from amine, carboxylic or hydroxyl groups,

b) optionally heating said polyamide oligomer to a temperature from 100 to 150° C. to make it a more processable liquid,

c) adding one or more non-reactive organic diluents,

d) adding to said polyamide oligomer about 10 to about 40 wt. % of a polyisocyanate component (optionally having blocked isocyanate group(s)) reactive with hydroxyl, carboxylic, and/or amino groups to form covalent chemical bonds with the nitrogen of said amino groups or the oxygen of said hydroxyl groups or reactions of said carboxylic groups with isocyanate, hydroxyl, or amine groups, wherein the weight percent diamine and carboxylic acid repeating units in said solution is from about 10 to about 75 wt. %, the amount of organic diluent is up to 50 wt. % of said solution, and the amount of said component reactive with hydroxyl, carboxylic, and/or amino groups is from about 10 to about 40 wt. % of said solution and wherein said solution at 50% solids and prior to reaction of said polyisocyanate has a viscosity at 25° C. measured by a Brookfield Rotating Disc viscometer, using a rotation speed of 5 rpm, and a #6 spindle of less than 10,000 cps (more desirably less than 2,000 cps, and preferably less than 500 cps).

18. The method of embodiment 17, wherein the organic diluent is evaporated from the solution and the isocyanate groups react with the hydroxyl, carboxylic, and/or amino groups to form covalent bonds.

19. The method of embodiment 18, wherein at least 50, more desirably at least 80, and preferably at least 90 mole % of said diamine are cyclic diamines where the nitrogen atoms are secondary and part of the ring and having 4 to 15 (more desirably 4 to 13) carbon atoms, such as piperazine or 4,4′-trimethlenedipiperidine.

20. The method of embodiment 18, wherein at least 50, more desirably at least 80, and preferably at least 90 mole % of said diamines are diamines having two primary amine groups, said diamines having primary two primary amine groups being of the structures

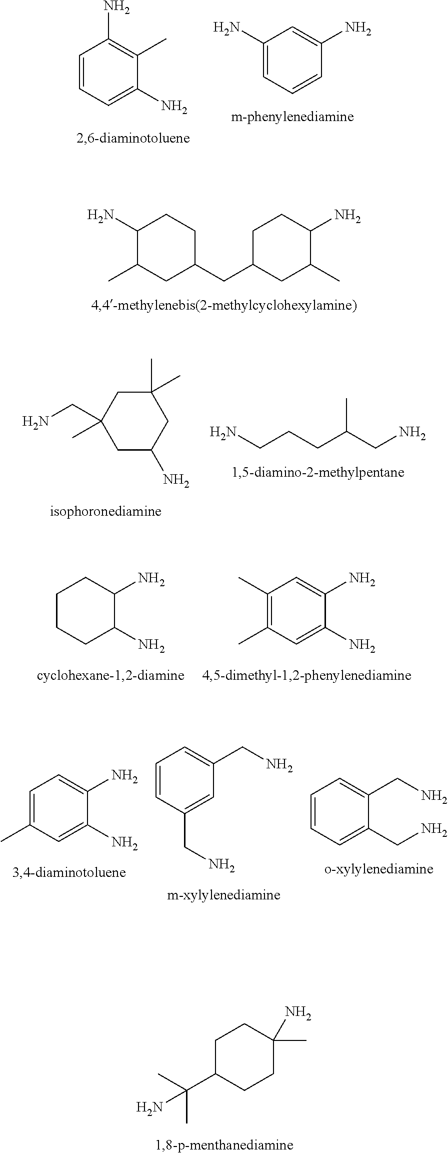

21. The method of any one of embodiments 17 to 20, wherein at least 50 wt. % (more desirably at least 60, 70, 80 or 90 wt. %) of the repeat units from carboxylic acids are derived from dicarboxylic acids of 10 to 50 carbon atoms, more desirably 25 to 50 carbon atoms.

22. The method of embodiment 21, wherein at least 50 wt. % (more desirably at least 60, 70, 80 or 90 wt. %) of the repeat units from carboxylic acids are derived from dimer fatty acids, optionally hydrogenated.

23. The method of any one of embodiments 17 to 20, wherein said component reactive with hydroxyl, carboxylic, and/or amino groups is a blocked polyisocyanate having two or more isocyanate groups in chemically blocked form that can be deblocked by thermal heating and said blocked polyisocyanate can be added to the polyamide oligomer without concern for a chemical reaction until such time that said blocked isocyanate groups are unblocked.

24. The method of any one of embodiments 17 to 23, further including a process step where up to 25 wt. % of one or more compounds of less than 500 g/mole molecular weight (not being a polyamide) having three or more groups reactive with isocyanates selected from the group of amine, carboxylic, and hydroxyl groups is added to the composition to facilitate crosslinking of the final composition.

25. The method of embodiment 17, wherein said polyisocyanate is not added until said composition is ready to form a coating or film and said polyisocyanate through its isocyanate groups begins to react with the polyamide oligomer upon addition of the polyisocyanate to the polyamide oligomer.

26. A thermosettable composition comprising:

a) 10 to 75 wt. % of a polyamide oligomer predominantly having two terminal end groups selected from the end groups of amine end groups, carboxylic end groups, and hydroxyl end groups,

b) 10 to about 40 wt. % of a component having two or more reactive oxirane rings (epoxy groups) reactive with amine, carboxylic, and/or hydroxyl groups to form covalent chemical bonds,

wherein said composition prior to reaction of said component having two or more reactive oxirane rings, when at or diluted to 50% solids has a viscosity at 25° C. of less than 10,000 cps (more desirably less than 5,000 cps, and preferably from about 100 to 5,000 cps) measured by a Brookfield Rotating Disc viscometer, using a rotation speed of 5 rpm (revolutions per minute), and a #6 spindle,

c) optionally one or more non-reactive organic diluents, and

d) up to 25 wt. % of one or more compounds of less than 500 g/mole molecular weight (not being a polyamide) having three or more groups reactive with a component having two or more reactive oxirane rings selected from the group of amine, carboxylic, and hydroxyl groups;

wherein said thermosettable composition of a), b), c) and d) prior to reaction of said a component having two or more reactive oxirane rings with said end groups selected from amine, carboxylic, and hydroxyl end groups, has an average functionality of all oxirane rings to combined amine, carboxylic, and hydroxyl groups of 2.1 or more per molecule; and

wherein said weight percentages are based on the total components to said thermosettable composition.

27. The thermosettable composition of embodiment 26, wherein the polyamide oligomer is polyamide repeat units derived from polymerizing

a) diamines having two amine groups capable of forming covalent bonds with a carbonyl of a carboxylic acid selected from the group consisting of diamines having from 4 to 60 carbon atoms (optionally including one other heteroatom) having two secondary terminal amine groups and/or diamines having from 4 to 60 carbon atoms (optionally including one other heteroatom) having one or two primary amine groups, wherein the diamines having one or two primary amine groups are characterized as diamines wherein a) substituents on carbon atoms adjacent to the primary amine nitrogen block the nitrogen from forming strong hydrogen bonding with nearby amide linkages and/or the primary amine nitrogen is pendant from an aliphatic or aromatic ring structure in a position from a ring such that the primary amine nitrogen cannot form strong hydrogen bonds with nearby amide linkages, with

b) lactone and or carboxylic acid monomers, wherein the lactone and/or carboxylic acid units are from an acid component selected from the group consisting of C₅ to C₈ lactone, C₅ to C₈ hydroxycarboxylic acids, and aliphatic dicarboxylic acids of 4 to 50 carbon atoms, wherein said lactone and/or carboxylic acid monomers form repeat units with a carbonyl from the lactone, hydroxycarboxylic acids, and aliphatic dicarboxylic acid reacting with an primary or secondary amine nitrogen to form amide linkage and thereby forming a polyamide oligomer.

28. The thermosettable composition of embodiment 27, wherein at least 40, desirably at least 50, more desirably at least 80, and preferably at least 90 mole % of said diamine are cyclic diamines where the nitrogen atoms are secondary and part of the one or more rings and having 4 to 15 (more desirably 4 to 13) carbon atoms, such as piperazine and 4, 4′-trimethylelenedipiperidine.

29. The thermosettable composition of the embodiment 27, wherein at least 50, more desirably at least 80, and preferably at least 90 mole % of said diamines are diamines having two primary amine groups, said diamines having primary two primary amine groups being of the structures

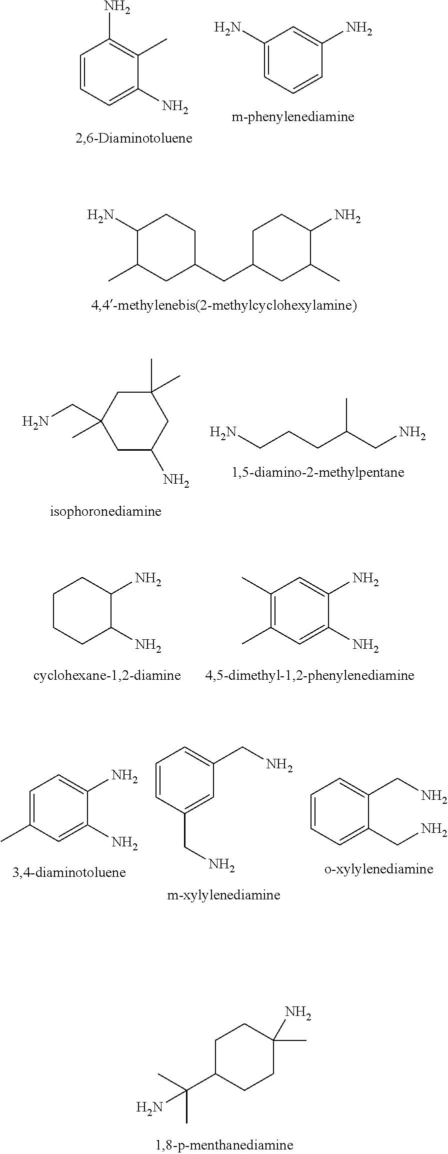

30. The thermosettable composition of any one of embodiments 27 to 29, wherein the polyamide oligomer is comprised of repeat units from dicarboxylic acids reacted with amine groups wherein at least 50, more desirably at least 80, and preferably at least 90 mole % of said dicarboxylic acid component being an amide repeat unit are dicarboxylic acids of 10 to 50 carbon atom.

31. The thermosettable composition of any one of the embodiments 27 to 30, wherein at least 50 wt. % (more desirably at least 60, 70, 80 or 90 wt. %) of the repeat units from carboxylic acids are derived from dimer fatty acids, optionally hydrogenated.

32. The thermosettable composition of any one of embodiments 27 to 30, wherein the combined repeat units of diamine and acid monomers forming at least one amide linkage during their polymerization into said polyamide are from 20 to about 60 wt. % of the thermosettable composition.

33. The thermosettable composition of any one of embodiments 27 to 30, wherein the combined repeat units of diamine and acid monomers forming at least one amide linkage during their polymerization into said polyamide are from 25 to about 50 wt. % of the thermosettable composition.

34. The thermosettable composition of any one of embodiments 27 to 30, wherein at least 90 wt. % of the repeat units from diamines are derived from cyclic diamines of 4 to 15 (more desirably 4 to 13) carbon atoms, wherein the nitrogen atoms of the diamine are part of the ring structure, such as piperazine or 4,4′-trimethylenepiperidine.

35. The thermosettable composition of any one of embodiments 27 to 30, wherein said organic diluent is present from about 10 to about 50 wt. % of said composition.

36. The thermosettable composition of any one of embodiments 27 to 30, wherein said organic diluent is selected from the group consisting of isopropanol, acetone, dimethyl carbonate and butyl acetate.

37. The thermosettable composition of any one of embodiments 26 to 30, wherein as the solution forms or film or coating by evaporation of the organic diluent, the polyamide oligomer is crosslinked via reactions with said component with two or more oxirane rings reactive with reactive groups selected from hydroxyl, carboxylic acid, and amino groups to form covalent chemical bonds to create a polymer of number average molecular weight of at least 1,000,000 g/mole.

38. A method for forming a thermosettable coating or film comprising:

a) polymerizing diamines selected from the group consisting of diamines having from 4 to 60 carbon atoms (optionally including one other heteroatom) having two secondary terminal amine groups and diamines having two primary amine groups, (desirably said diamines having primary two primary amine groups being of the structures

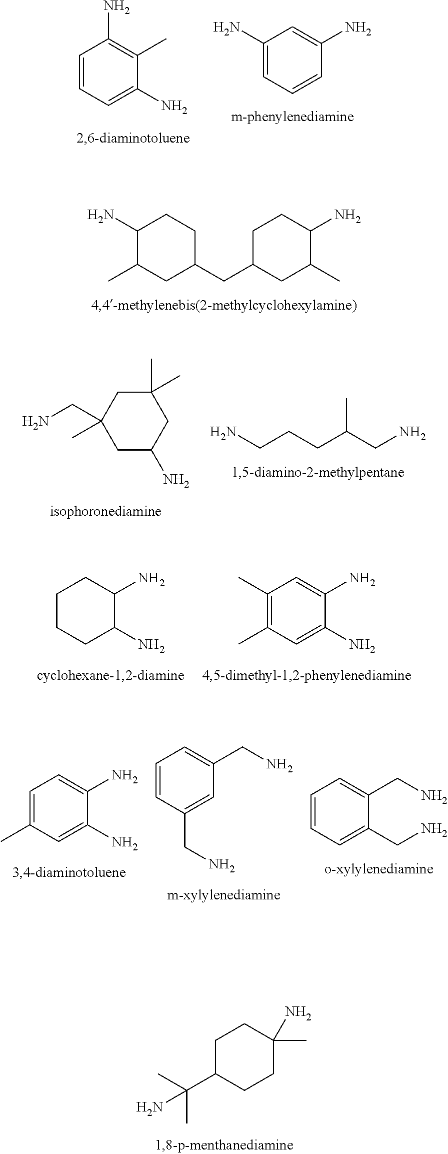

reacted with carboxylic acid groups, wherein the carboxylic acid units are from a lactone and/or a carboxylic acid component selected from the group consisting of C₅ to C₈ lactone, C₅ to C₈ hydroxycarboxylic acids, and aliphatic dicarboxylic acids of 4 to 50 carbon atom forming repeat units with a carbonyl or nitrogen as part of an amide linkage and thereby forming a polyamide oligomer; and wherein said polyamide oligomer has at least two terminal groups selected from amine, carboxylic, and hydroxyl groups,

b) optionally heating said polyamide oligomer to a temperature from 100 to 150° C. to make it a more processable liquid,

c) adding one or more non-reactive organic diluents, and

d) adding to said polyamide oligomer about 10 to about 40 wt. % a component having two or more reactive oxirane rings reactive with hydroxyl, carboxylic, or amino groups to form covalent chemical bonds with the nitrogen of said amino groups, carboxyl of said carboxylic groups, or the oxygen of said hydroxyl groups for a pourable solution at 25° C., wherein the weight percent diamine and carboxylic acid repeating units in said solution is from about 10 to about 75 wt. %, the amount of organic diluent is up to 50 wt. % of said solution, and the amount of said component having two or more reactive oxirane rings reactive with hydroxyl, carboxylic, and/or amino groups is from about 10 to about 40 wt. % of said solution and wherein said solution at 50% solids and prior to the reaction of said component having two or more oxirane rings has a viscosity at 25° C. measured by a Brookfield Rotating Disc viscometer, using a rotation speed of 5 rpm, and a #6 spindle of 1 of less than 10,000 cps (more desirably less than 2,000 cps, and preferably less than 500 cps).

39. The method of embodiment 38, wherein the organic diluent is evaporated from the solution and the component having two or more reactive oxirane rings reacts with the hydroxyl group, carboxylic acid group, and/or amino groups to form covalent bonds.

40. The method of embodiment 38, wherein, wherein at least 50, more desirably at least 80, and preferably at least 90 mole % of said diamine are cyclic and/or dicyclic diamines where the nitrogen atoms are secondary nitrogen groups and part of the ring and having 4 to 15 (more desirably 4 to 13) carbon atoms, such as piperazine or 4,4′-trimethlenedipiperidine.

41. The method of embodiment 38, wherein, wherein at least 50, more desirably at least 80, and preferably at least 90 mole % of said diamines are diamines having two primary amine groups, desirably said diamines having primary two primary amine groups being of the structures

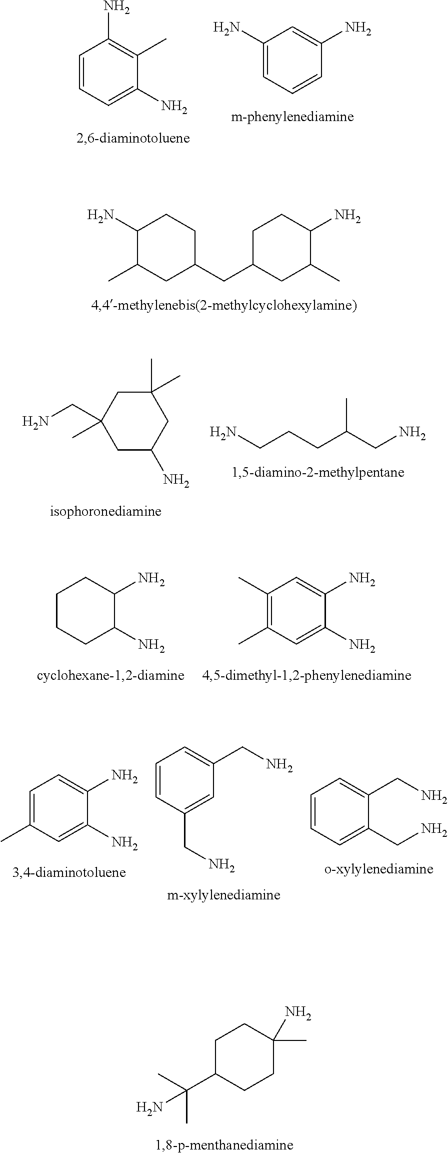

42. The method of embodiment 38, wherein at least 50 wt. % (more desirably at least 60, 70, 80 or 90 wt. %) of the repeat units from carboxylic acids are derived from dicarboxylic acids of 10 to 50 carbon atoms, more desirably 25 to 50 carbon atoms.

43. The method of embodiment 38, wherein at least 50 wt. % (more desirably at least 60, 70, 80 or 90 wt. %) of the repeat units from carboxylic acids are derived from dimer fatty acids, optionally hydrogenated.

44. The method of embodiment 38, further including a process step where up to 25 wt. % of one or more compounds of less than 500 g/mole molecular weight (not being a polyamide) having three or more groups reactive with a component having two or more reactive oxirane rings is added to the composition to facilitate crosslinking of the final composition.

### DETAILED DESCRIPTION OF THE INVENTION

Thermoset films or thermoset polymer solutions with higher percentages of polyamide segments are disclosed for a variety of uses where the strength and/or chemical resistance of polymers with polyether, polyester, or polycarbonates segments is deficient. The solutions are useful because the polyamides are formulated to be sufficiently soft at their molecular weight to form solutions that are pourable from a beaker at 20-50° C. with solids contents above 30, 40, 50, 60, 70 or 80 wt. % polymeric components (polymeric components being defined as non-volatile or polymer forming components) with the complementary amount (the amount necessary with the non-volatile components to make 100 wt. % or the total) of a volatile solvent.

A first benefit of this technology is to have a thermoset composition rich in polyamide content. Amide linkages, especially in a thermoset composition, have good resistance to deformation, UV, moisture, etc. Since more conventional polyamides require relatively high temperature to process due to intermolecular hydrogen bonds, excluding other polymers and solvent, it is difficult to develop thermoset polyamides. By using low molecular weight polyamides, we can improve solvent interaction and promote compatibility with other polymers.

A second benefit of the first portion of this invention (substituting low glass transition point (T_{g}) polyamide segments for polyether or polyester segments) is that the polyamide segments tend to promote better wetting and adhesion to a variety of polar substrates, such as glass, nylon, and metals as compared to polyester or polyether-based polyurethanes. The hydrophobic/hydrophilic nature of the polyamide can be adjusted by using different ratios of hydrocarbyl portion to amide linkages in the polyamide. Diacids, diamines, aminocarboxylic acids, and lactones with large carbon to nitrogen ratios tend to be hydrophobic. When the carbon to nitrogen ratio in the polyamide becomes smaller, the polyamide becomes more hydrophilic.

Thus, polymers made from polyamide segments can have good solvent resistance. Resistance to solvents is desirable for a coating or ink. Solvents can deform and stress a polymer by swelling, thereby causing premature failure of the polymer or parts from the polymer. Solvents can cause a coating to swell and delaminate from a substrate at the interface between the two. Adding polyamide to a polymer can increase adhesion to substrates that have similar or compatible polar surfaces to polyamides.

One objective of the current patent application is to use high percentages of amide linkages in polymer segments incorporated via reaction with polyisocyanates or compounds with two or more oxirane rings into a thermoset copolymer, optionally elastomeric properties to provide resistance to chain scission from hydrolysis and UV activated chain scission. Some embodiments may allow for some linkages between repeat units to be other than amide linkages. In some embodiments, the linkages between the polyamide oligomer and the isocyanate groups of the polyisocyanate will have significant portions of urea linkages. Urea linkages tend to have a higher melting temperature than urethane linkages and therefore provide higher use temperatures. Some embodiments may allow for urethane linkages between polyamide oligomers and the isocyanate groups of the polyisocyanate component, when preventing chain scission is not a top priority.

An important modification from conventional polyamides to get low T_{g} polyamide soft segments is to use one or more of 1) diamine monomers with secondary amine terminal group, 2) diamines having cyclic rings and steric factors preventing close packing and strong hydrogen bonding of the amide linkages, and 3) diamines having one or two primary amine groups characterized as diamines wherein a) substituents on carbon atoms adjacent to the primary amine nitrogen block the nitrogen of the amide from forming strong hydrogen bonding with nearby amide linkages. The amide linkage formed from a secondary amine and a carboxylic acid type group is called a tertiary amide linkage. Primary amines react with carboxylic acid type groups to form secondary amides. The nitrogen atom of a secondary amide has an attached hydrogen atom that often hydrogen bonds with a carbonyl group of a nearby amide if some type of steric hindrance is not present. The intra-molecular H-bonds induce crystallinity with high melting point and act as crosslinks, reducing chain mobility. With tertiary amide groups the hydrogen on the nitrogen of the amide linkage is eliminated along with hydrogen bonding. A tertiary amide linkage that has one additional alkyl group attached to it as compared to a secondary amide group, which has hydrogen attached to it, has reduced polar interactions with nearby amide groups when the polymer exists in a bulk polymer sample. Reduced polar interactions mean that glassy or crystalline phases that include the amide linkage generally melt at lower temperatures than similar amide groups that are secondary amide groups. One way to source secondary amine reactant, a precursor to tertiary amide linkages, is to substitute the nitrogen atom(s) of the amine containing monomer with an alkyl group. Another way to source a secondary amine reactant is to use a heterocyclic molecule where the nitrogen of the amine is part of the ring structure. Piperazine is a common cyclic diamine where both nitrogens are of the secondary type and part of the heterocyclic ring.

The crosslinkable or thermoset compositions of this disclosure are desired because they have high weight percentages of polyamide repeat units in their polyamide oligomers, reasonable amounts of a component (often a polyisocyanate or an epoxy compound of the type with two or more oxirane rings capable of reacting with Zerewitinoff groups) capable of chemically reacting with the terminal groups of the polyamide oligomer to form a thermoset composition, and if needed a solvent in amounts sufficient to lower the viscosity of the thermosettable composition to a pourable composition at 20-30° C. and one capable of forming coatings or films at 20, 25 or 30° C. without undue difficulty.

In one embodiment, the repeat units of amide type include diamines (where the amine terminal groups have reacted with a carboxylic acid to form an amide linkage, as described later, and carboxylic acid components that have reacted with an amine to form an amide). The polyamide oligomer can include other repeat units other than the amide type repeat units, but it is the intent to use a majority of amide forming repeating units in the polyamide oligomer.

The amount of amide forming repeat units in the thermosettable composition (including the solvent if present) is from about 10 or 15 to about 75 wt. % of the thermosettable composition, more desirably from about 15 or 20 to about 60 wt. %, and preferably about 15, 20 or 25 to about 50 wt. %. The amount of the component reactive with the polyamide oligomers (often a polyisocyanate and sometimes a blocked isocyanate compound) is from about 10 to about 50 wt. % of the thermosettable composition, more desirably from about 10 to about 40 wt. %, and preferably from about 15 to about 35 wt. %. The amount of solvent is desirably up to 60 wt. % of the thermosettable composition, more desirably from 10 to 60 wt. % of the composition, more desirably from 10 to 50 wt. % of the composition, and preferably from about 10 to 30 wt. %. There are optionally present low molecular weight components that are di- or tri-functional or higher (preferably tri-functional or higher than can be present up to 15 wt. % of the thermosettable composition). The thermosettable composition can also include pigments in conventional amounts, coalescents in conventional amounts, fillers, biocides, film enhancers, film surface modifiers (e.g., gloss reduction agents) and other components conventionally used in coatings, inks and films.

Because we want a thermoset, the polyamide will generally have a reactive terminal group at both ends. The reactive groups can be Zerewitinoff groups, such as hydroxyl and/or amine groups. Also, in some embodiments the polyamide can be carboxylic acid terminated. The carboxylic acid can react directly with polyepoxides to form higher molecular weight reaction products (chain extended with polyepoxides). The carboxylic acid terminated polyamides can promote the degradation of isocyanate groups (from the polyisocyanate component) to release one molecule of CO₂ and an amine group (a well-known reaction of isocyanate groups with carboxylic acid groups). Thereafter, the amine generated from the isocyanate group can react with a carboxylic acid group on the polyamide or with additional isocyanate groups (if present). The overall result is that carboxylic acid terminated polyamides can be reacted into higher molecular weight or crosslinked reaction products. In preferred embodiments the terminal groups of the polyamide are amine or hydroxyl terminal groups as those avoid the generation of CO₂. Amine (primary or secondary) terminal groups can be achieved by using a molar excess of the diamine component, relative to the carboxylic acid component in making the polyamide. Hydroxyl terminal groups can be introduced in a variety of ways. One way is to initially form an amine terminated polyamide and then react that polyamide with a hydroxyl carboxylic acid of 3 to 30 carbon atoms or a lactone of 2 to 10 (or 4 to 10) carbon atoms. If the molar amount of carboxyl functional groups in the hydroxycarboxylic acid and/or lactone are equivalent to the number of terminal amine groups, one gets a single unit from the hydroxycarboxylic acid or lactone. If a molar excess of the hydroxycarboxylic acid and/or lactone is used, one develops short polyester segments as part of the polyamide. One can also generate a carboxylic acid terminated polyamide and convert the carboxylic acid groups to hydroxyl groups by reacting with an amino alcohol of 2 to 20 carbon atoms.

Sometimes a carboxylic acid terminated telechelic polyamide segment is functionalized by reacting with an aminoalcohol, such as N-methylaminoethanol or HN(R^{α})(R^{β}) where R^{α} is a C₁ to C₄ alkyl group and R^{β} comprises an alcohol group and a C₂ to C₁₂ alkylene group, alternatively R^{α} and R^{β} can be interconnected to form a C₃ to C₁₆ alkylene group including a cyclic structure and pendant hydroxyl group (such as in 2-hydroxymethyl piperidine), either of which can create a telechelic polyamide with terminal hydroxyl groups. The reaction of the secondary amine (as opposed to the hydroxyl group) with the carboxylic acid can be favored by using a 100% molar excess of the amino alcohol and conducting the reaction at 160° C.+/−10 or 20° C. The excess amino alcohol can be removed by distillation after reaction.

In embodiments using blocked isocyanate groups, the polyisocyanate can be added to the other components, (e.g., the solvent, the polyamide, and optional crosslinking compounds with 3 or more Zerewitinoff groups) and packaged for shipment to the end user. If a conventional non-blocked polyisocyanate is used with the polyamide and solvent, that non-blocked polyisocyanate is not added until immediately before use of the coating, adhesive or ink. The non-blocked isocyanate groups react quickly (depending on temperature and the presence of any catalysts for urethane formation) with Zerewitinoff groups present. An optional urethane forming catalyst can also be in the formulation with either blocked or non-blocked polyisocyanate. These catalysts for urethane formation are well known in the art.

The polyamide, solvent, and other polymer forming components (typically present at 50% solids or greater) will have a viscosity measured by a Brookfield Circular Disc viscometer (such as a Model LV, RV, HA or HB, where the designation indicates the four basic spring torques) with the circular #6 disc spinning at 25° C. and 5 rpm of less than 10,000 cps, more desirably less than 5,000 cps, and in some embodiments less than 2,000 or 500 cps, still more desirably from about 100 to 5,000 cps (when measured at 50 wt. % solids). The compositions can be diluted with more solvent if they are initially greater than 50% solids for the purpose of measuring viscosity and determining if the viscosities are in the required range. These types of viscosities will facilitate pouring the polyamide in solvent from a one-gallon paint can or other container at 25° C. to facilitate applying the material to a substrate.

The term polyamide oligomer will refer to an oligomer with two or more amide linkages, or sometimes the amount of amide linkages will be specified. Generally, the polyamide oligomers will have at least one diamine component and either at least one diacid component or at least two hydroxycarboxylic acid and/or lactone components (to generate at least two amide linkages). As shown in the examples, generally the polyamide with have from 1 to 20, more desirably from 1 to 10 diamines per polyamide oligomer.

We will define polyamide oligomer as a species below 5,000 g/mole number average molecular weight (e.g., often below 2,500, or 2,000 g/mole) that has two or more amide linkages per oligomer. Generally, the polyamides will have a number average molecular weight of at least 300 and more desirably at least 400 g/mole.

Generally, amide linkages are formed from the reaction of a carboxylic acid group with an amine group or the ring opening polymerization of a lactone (e.g., where an ester linkage in a ring structure is converted to an amide linkage in a polymer with a terminal hydroxyl group). As previously indicated, multiple repeat units from a lactone can be added to a polyamide by ring opening polymerization of a lactone. The formation of amides from the reaction of carboxylic acid groups and amine groups can be catalyzed by boric acid, boric acid esters, boranes, phosphorous acid, phosphates, phosphate esters, amines, acids, bases, silicates, and silsesquioxanes. Additional catalysts, conditions, etc. are available in textbooks such as “Comprehensive Organic Transformations” by Larock.

The polyamides of this disclosure can contain small amounts of ester linkages, ether linkages, urethane linkages, urea linkages, etc. if the additional monomers used to form these linkages are useful to the intended use of the polymers. This allows other monomers and oligomers to be included in the polyamide to provide specific properties, which might be necessary and not achievable with a 100% polyamide segment oligomer. Sometimes added polyether, polyester, or polycarbonate provides softer (lower T_{g}) segments. Sometimes it is desirable to convert the carboxylic end groups or primary or secondary amine end groups of a polyamide to other functional end groups capable of condensation polymerizations.

Preferred amide or tertiary amide forming monomers include dicarboxylic acids, hydroxycarboxylic acid, lactones, diamines, aminocarboxylic acids and lactams.

Preferred dicarboxylic acids are where the alkylene portion of the dicarboxylic acid is a cyclic, linear, or branched (optionally including aromatic groups) alkylene of 2 to 48 carbon atoms, optionally including up to 1 heteroatom per 2 (or 1 heteroatom per 10) carbon atoms, more preferably from 8 to 38 carbon atoms (the diacid would include 2 more carbon atoms than the alkylene portion or 4-50 carbon atoms and more preferably 10 to 40 or 10 to 50 carbon atoms and in some embodiments from 25 to 50 carbon atoms). These include dimer fatty acids, hydrogenated dimer acid, sebacic acid, etc. Generally, we prefer diacids with larger alkylene groups as this generally provides polyamide repeat units with lower T_{g} value. Hydrogenation of dimer fatty acids makes them less reactive later through the elimination of carbon-carbon double bonds by hydrogenation.

Preferred hydroxycarboxylic acids would have from 3 to 30 carbon atoms and more preferably from 5 to 8 carbon atoms. Preferred lactones would have from 2 to 10 (or 4 to 10) carbon atoms and preferably from 5 to 8 carbon atoms.

Preferred diamines include those with up to 60 carbon atoms, optionally including 1 heteroatom (besides the two nitrogen atoms) for each 3 (or 1 heteroatom (besides the two nitrogen atoms) for each 10) carbon atoms of the diamine and optionally including a variety of cyclic, aromatic or heterocyclic groups providing that one or both amine groups are secondary amines; a preferred formula is

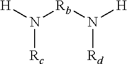

wherein R_{b} is a direct bond or a linear or branched (optionally being or including cyclic, heterocyclic, or aromatic portion) alkylene group (optionally containing up to 1 heteroatoms per 10 (or 3 heteroatoms per 10) carbon atoms of the diamine) of 2 to 36 carbon atoms and more preferably 2 to 12 (or 4 to 12) carbon atoms; and R_{c} and R_{d} are individually a linear or branched alkyl group of 1 to 8 carbon atoms, more preferably 1 to 4 (or 2 to 4) carbon atoms; or R_{c} and R_{d} connect together to form a single linear or branched alkylene group of 1 to 8 carbon atoms or optionally with one of R_{c} and R_{d} is connected to R_{b} at a carbon atom, more desirably R_{c} and R_{d} being 1 to 4 (or 2 to 4) carbon atoms. Such diamines include Ethacure™ 90 from Albermarle, a N,N′-bis(1,2,2-trimethylpropyl)-1,6-hexanediamine; Clearlink™ 1000 or Jefflink™ 754, both from Huntsman; N-methylaminoethanol; dihydroxy terminated, hydroxyl and amine terminated or diamine terminated poly(alkyleneoxide) where the alkylene has from 2 to 4 carbon atoms and having molecular weights from 100 to 2000; N,N′-diisopropyl-1,6-hexanediamine; N,N′-di(sec-butyl) phenylenediamine; piperazine; homopiperazine; and methyl-piperazine. Jefflink™754 has the structure

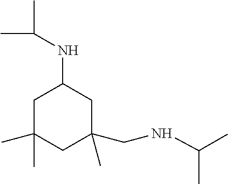 [SMILES: CC(C)NCC1(C)CC(NC(C)C)CC(C)(C)C1]

and Clearlink™ 1000 has the structure

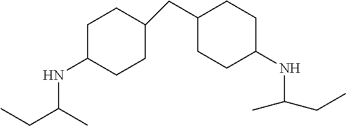 [SMILES: CCC(C)NC1CCC(CC2CCC(NC(C)CC)CC2)CC1]

In one embodiment, the diamines are HNR¹—CHR²—X—CHR³—NR⁴H, where X is a hydrocarbon or a direct linkage with 0 to 34 carbon atoms, R¹, R², R³ and R⁴ are H, the alkyl groups below, or alkylene bridge group below, and at least 2 of the four substituent R¹, R², R³ and R⁴ are either alkyl groups with 1-4 carbons, or are part of an alkylene bridge group between the connection point for two substituents selected R¹, R², R³ and R⁴, forming a 5 to 7 membered hydrocarbon ring.

Another diamine with an aromatic group is: N,N′-di(sec-butyl) phenylenediamine, see structure below:

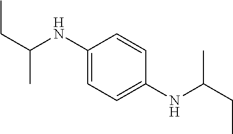 [SMILES: CCC(C)Nc1ccc(NC(C)CC)cc1]

In one embodiment, preferred diamines are diamines wherein both amine groups are secondary amines.

Preferred lactams include straight chain or branched alkylene segments therein of 4 to 12 carbon atoms such that the ring structure, without substituents on the nitrogen of the lactam, has 5 to 13 carbon atoms total (when one includes the carbonyl) and the substituent on the nitrogen of the lactam (if the lactam is a tertiary amide) is an alkyl of from 1 to 8 carbon atoms and more desirably an alkyl of 1 to 4 carbon atoms. Dodecyl lactam, alkyl substituted dodecyl lactam, caprolactam, alkyl substituted caprolactam, and other lactams with larger alkylene groups are preferred lactams as they provide repeat units with lower T_{g} values. Aminocarboxylic acids have the same number of carbon atoms as the lactams. Desirably, the number of carbon atoms in the linear or branched alkylene group between the amine and carboxylic acid group of the aminocarboxylic acid is from 4 to 12 and the substituent on the nitrogen of the amine group (if it is a secondary amine group) is an alkyl group with from 1 to 8 carbon atoms, more preferably 1 to 4 (or 2 to 4) carbon atoms. Aminocarboxylic acids with secondary amine groups are preferred.

In one embodiment, desirably at least 50 wt. %, more desirably at least 60, 70, 80 or 90 wt. % of said polyamide oligomer comprise repeat units from diacids and diamines of the structure of the repeat unit being

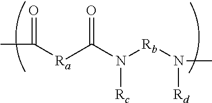

wherein Rₐ is the alkylene portion of the dicarboxylic acid and is a cyclic, linear, or branched (optionally including aromatic groups) alkylene of 2 to 48, more desirably from 8 to 38 carbon atoms, optionally including up to 1 heteroatom per 3 (or 1 heteroatom per 10) carbon atoms of the diacid, (the diacid would include 2 more carbon atoms than the alkylene portion of the diacid); and wherein R_{b} is a direct bond or a linear or branched (optionally being or including cyclic, heterocyclic, or aromatic portion(s)) alkylene group (optionally containing up to 1 heteroatom per 10 (or 3 heteroatoms per 10) carbon atoms) of 2 to 36 or 2 to 60 carbon atoms and more preferably 2 to 12 or 4 to 12 carbon atoms; and Rₑ and R_{d} are individually a linear or branched alkyl group of 1 to 8 carbon atoms, more preferably 1 to 4 (or 2 to 4) carbon atoms; or Rₑ and R_{d} connect together to form a single linear or branched alkylene group of 1 to 8 carbon atoms; or optionally with one of Rₑ and R_{d} is connected to R_{b} at a carbon atom, more desirably Rₑ and R_{d} together being an alkylene group of 1 to 4 (or 2 to 4) carbon atoms.

In one embodiment, desirably at least 50 wt. %, more desirably at least 60, 70, 80 or 90 wt. % of said polyamide oligomer or telechelic polyamide comprise repeat units from lactams or amino carboxylic acids of the structure

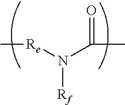

wherein repeat units can be in a variety of orientations depending on initiator type in the oligomer, derived from lactams or amino carboxylic acid wherein each Rₑ independently is linear or branched alkylene of 4 to 12 carbon atoms and each R_{f} independently is a linear or branched alkyl of 1 to 8 (more desirably 1 to 4) carbon atoms.

The above described polyamide is useful to make solutions with polyisocyanates. Polyisocyanates will be used in this specification to refer to isocyanate containing species having two or more isocyanates groups per molecule. Desirably, the polyamides have terminal groups reactive with isocyanates to form urea linkages and/or urethane linkages. Groups chemically reactive with isocyanates to form chemical linkages are known as Zerewitinoff groups and include primary and secondary amines and primary and secondary alcohols. The nitrogen of the primary or secondary amine bonds to a carbonyl of the isocyanate and a hydrogen from the primary or secondary amine moves from the amine and bonds to the NH group of the isocyanate. The oxygen of a primary or secondary alcohol bonds to the carbonyl of the isocyanate and a hydrogen from the hydroxyl group of the alcohol moves and bonds to the NH group of the isocyanate.

In a second embodiment, preferred diamines are specific diamines with specific structures shown below that result in soluble polyamide at 20-30° C. that can be the basis of thermoset liquid compositions pourable at 20-30° C. and reasonable solvent content. In a third embodiment, preferred diamines are combinations of diamines with secondary amine terminal groups in combination with the specific primary diamines below that also result in soluble polyamides at 20-30° C. that can be the basis for pourable thermoset compositions.

The following are examples of aliphatic, cycloaliphatic, and aromatic diamines with primary amine terminal groups that did result in soluble polyamides when reacted with aliphatic diacids such as sebacic acid and/or dimer fatty acids. While not wishing to be bound by theory, it is believed that their substantially non-linear structure when drawn with appropriate bond angles and bond lengths and the sterically bulky ring structures, results in a polyamide that is fairly non-linear and cannot closely pack together and easily rearrange to strengthen hydrogen bonding to adjacent or nearby amide linkages and therefore these polyamines and similar polyamines provide opportunity for compatible polar solvents to provide solubilization at temperatures between 10 and 150° C.

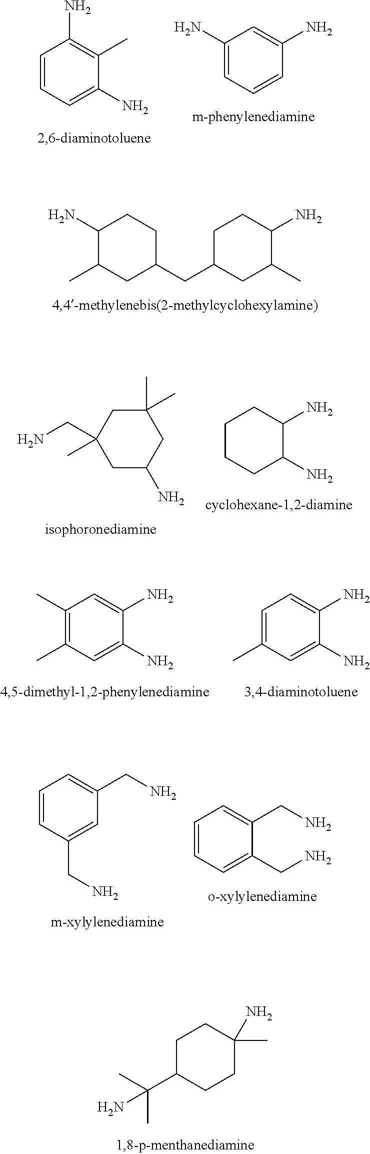

Additionally, it has been found that two other diamines tend to form solvent compatible polyamides that are useful as components in this disclosure. They are 1,5-diamino-2-methyl pentane and 4, 4′-trimethylenedipiperidine. The structures for these molecules are shown below.

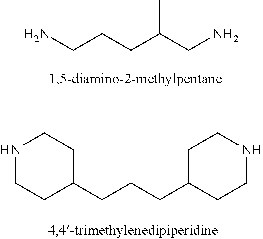

The following are examples of aliphatic, cycloaliphatic, and aromatic diamines that did not result in soluble polyamides when reacted with aliphatic diacids such as sebacic acid and/or dimer fatty acids. While not wishing to be bound by theory, it is believed that their substantially linear structure when drawn with appropriate bond angles and bond lengths, results in a polyamide that is fairly linear and can closely pack together and hydrogen bond to adjacent or nearby polyamides with minimal opportunity for compatible polar solvents to provide solubilization at temperatures between 10 and 150° C.

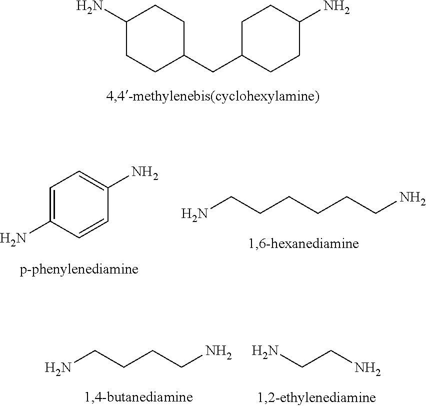

It is also acknowledged that the molecular weight of the polyamide sections is often controlled by using an excess of one component to form terminal end groups of the component used in excess, such as the diamine component (relative to the diacid component) can be used in excess to form amine terminated polyamide sections of controlled or lower molecular weight than would have been achieved if a 1:1 stoichiometry between the amine groups and the carboxylic acid groups would have been used. The amine terminated polyamides react with polyisocyanates to form urea linkages (which are generally higher softening temperatures than linkages formed between hydroxyl groups and polyisocyanates). So, in some examples we have reacted the amine terminated oligomers with caprolactone to form hydroxyl terminated polyamides (with a slightly lower softening temperature). Additional caprolactone units can be added to the hydroxyl terminal group to form an oligomer from ring opening caprolactone repeat units onto the polyamide oligomer. Having polycaprolactone segments helps soften the composition and lowers the softening temperature of the polyamide rich oligomers.

The processes for making the polyamides is optimized to produce a waxy solid telechelic polyamide rich polymer at room temperature that can be melted without solvents at temperatures between 100 and 140° C., more desirably 110 to 130° C. and preferably 120 to 130° C. to form liquid telechelic polyamide rich oligomers that can be blended with compounds reactive with the telechelic oligomers' end groups (Zerewitinoff groups and preferably hydroxyl or amine groups (preferably secondary amine groups) to form covalent bonds). Then while the telechelic oligomers are liquid at elevated temperatures (and prior to, during, or after the addition of the compound reactive with the telechelic end groups) a solvent is added to convert the polyamide rich composition to an easily stirred liquid (viscosity at 50 wt. % solids with a Brookfield Rotating Disc/spindle viscometer of less than 10,000 or 5,000 cps, in some embodiments less than 2,000 or less than 500 cps, more desirably from about 100 to 5,000 cps at 25° C. using a rotation speed of 5 rpm, and a #6 spindle).

Useful solvents for this disclosure are those with boiling points at one atmosphere pressure between 40 and 120° C. and having from 2 to 10 carbon atoms and one or more oxygen atom and one or more hydrogen atoms. Compounds used as solvents in the examples include isopropanol, acetone, dimethyl carbonate, and butyl acetate.

Suitable polyisocyanates have an average of about two or more isocyanate groups, preferably an average of about two to about four isocyanate groups per molecule and include aliphatic, cycloaliphatic, araliphatic, aromatic, and heterocyclic polyisocyanates, as well as products of their oligomerization, used alone or in mixtures of two or more. Diisocyanates are more preferred.

Specific examples of suitable aliphatic polyisocyanates include alpha, omega-alkylene diisocyanates having from 5 to 20 carbon atoms, such as hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include hexamethylene-1,6-diisocyanate, 2,2,4-trimethyl-hexamethylene-diisocyanate, and 2,4,4-trimethyl-hexamethylene diisocyanate.

Specific examples of suitable cycloaliphatic polyisocyanates include dicyclohexylmethane diisocyanate, (commercially available as Desmodur™ W from Bayer Corporation), isophorone diisocyanate, 1,4-cyclohexane diisocyanate, 1,3-bis-(isocyanatomethyl) cyclohexane, and the like. Preferred cycloaliphatic polyisocyanates include dicyclohexylmethane diisocyanate and isophorone diisocyanate.

Specific examples of suitable araliphatic polyisocyanates include m-tetramethyl xylylene diisocyanate, p-tetramethyl xylylene diisocyanate, 1,4-xylylene diisocyanate, 1,3-xylylene diisocyanate, and the like. A preferred araliphatic polyisocyanate is tetramethyl xylylene diisocyanate.

Examples of suitable aromatic polyisocyanates include 4,4′-diphenylmethylene diisocyanate, toluene diisocyanate, their isomers, naphthalene diisocyanate, and the like.

Preferred aromatic polyisocyanates include 4,4′-diphenylmethylene diisocyanate and toluene diisocyanate.

Examples of suitable heterocyclic isocyanates include 5,5′-methylenebisfurfuryl isocyanate and 5,5′-isopropylidenebisfurfuryl isocyanate.

In some embodiments of this invention, blocked isocyanate reactants can be used to minimize the reaction of isocyanate groups and inherent viscosity increase until the correct time to allow molecular weight increases of the reactants. Blocked isocyanate groups are well known in the art and compounds with blocked isocyanate groups are commercially available, and at least one blocked isocyanate compound is shown in the examples. Generally blocked isocyanate groups are thermally de-blocked by heating the reactants. Some blocked isocyanate compounds used ketoxime chemistry which is described and known in the literature.

In some embodiments one uses low molecular weight polyols and/or polyamines to provide “chain extension” and/or “crosslinking” of isocyanate terminated reactants or reaction mixtures that include polyisocyanates. Examples include low molecular weight polyols and polyamines with number-average molecular weight less than about 500 Daltons. “Polyol” in this context means any product having an average of about two or more hydroxyl groups per molecule. Polyamine in this context is used to describe compounds with two or more primary or secondary amine groups, capable of reacting with isocyanate groups to form urea linkages. Specific examples include aliphatic, cycloaliphatic and aromatic polyols, especially diols, having 2-20 carbon atoms, more typically 2-10 carbon atoms, such as 1,4-butanediol. Specific examples of polyamines include aliphatic, cycloaliphatic and aromatic polyamines, especially diamines and triamines, having 2-20 carbon atoms, more typically 2-10 carbon atoms, such as ethylenediamine and similar alkylene di and triamines. Polyamines can include hydrazine and compounds built from reacting diacids with hydrazine, such as adipic acid dihydrazide. Lower molecular weight compounds are preferred as lower molecular weight compounds migrate more quickly through a composition than oligomeric or polymeric species. Any other compounds known to function as chain extenders in polyester polyols and polyamides can also be used.

In some embodiments, one could use trifunctional isocyanates compounds and higher isocyanate functional polyisocyanates. Sometimes these are formed by trimerizing lower functionality diisocyanates or sometimes they are formed by reacting di and/or tri-isocyanates with triols, tetrahydric alcohols and higher functionality alcohols. They can also be made by reacting tri-amines and higher functionality amines with di and/or tri-isocyanates. Other polyfunctional isocyanate compounds can be made from tri and higher functionality amines and traditional reactions to convert amine groups to isocyanate groups.

Preferred epoxy resins are liquid resins based off bisphenol compounds, especially from bisphenol A, bisphenol F or bisphenol A/F, such as those available from Dow, Huntsman and Hexion. These liquid resins have a low viscosity for epoxy resins and in the fully hardened state, good properties as coatings. They can optionally be present in combination with bisphenol A solid resin or bisphenol F novolac epoxy resin.

Also suitable as an epoxy resin is an aliphatic or cycloaliphatic polyepoxide, such as a glycidyl ether of a saturated or unsaturated, branched or unbranched, cyclic or open-chain C₂ to C₃₀ diol, such as ethylene glycol, propylene glycol, butylene glycol, hexanediol, octanediol, a polypropylene glycol, dimethylolcyclohexane, neopentylglycol or dibromo-neopentyl glycol, a glycidyl ether of a tri- or tetrafunctional, saturated or unsaturated, branched or unbranched, cyclic or open-chain polyol such as castor oil, trimethylolpropane, trimethylolethane, pentaerythritol, sorbitol or glycerol, as well as alkoxylated glycerol or alkoxylated trimethylolpropane; a hydrogenated bisphenol A, F or A/F liquid resin, or the glycidylation products of hydrogenated bisphenol A, F or A/F; a N-glycidyl derivative of amides or heterocyclic nitrogen bases, such as triglycidyl cyanurate and triglycidyl isocyanurate, as well as reaction products from epichlorohydrin and hydantoin.

Finally, other suitable epoxy resins are epoxy resins from the oxidation of olefins, for example from the oxidation of vinylcylohexene, dicyclopentadiene, cyclo-hexadiene, cyclododecadiene, cyclododecatriene, isoprene, 1,5-hexadiene, butadiene, polybutadiene or divinylbenzene.

The epoxy resin can contain a reactive diluent, especially a reactive diluent having at least one epoxide group. Suitable reactive diluents are, for example, the glycidyl ethers of monovalent or polyvalent phenols and aliphatic or cycloaliphatic alcohols.

Other additives well known to those skilled in the art can be used to aid in preparation of the thermosettable compositions of this invention. Such additives include surfactants, stabilizers, defoamers, flash rust inhibitors, adhesion promoters, coalescents, surface tension modifiers, plasticizers, thickeners, leveling agents, antimicrobial agents, fungicides, antioxidants, UV absorbers, slip modifiers, fire retardants, pigments, fillers, dyes, and the like. These additives are well known to the art and can be added at any stage of the manufacturing process. These will all be used in conventional amounts for conventional purposes in coatings and adhesives.

As coating compositions or adhesives, the compositions of this disclosure may be applied to any substrate including wood, metals, glass, cloth, leather, paper, plastics, foam and the like, by any conventional method including brushing, dipping, flow coating, spraying, and the like. They will protect the substrate from various environmental substances like water, chemicals, corrosives materials, dirt, ozone, soot, etc. and provide an easy to clean surface.

The compositions of the present invention and their formulations are useful as self-supporting films, coatings on various substrates, or adhesives with longer useful lifetimes than similar polyurethane compositions or other improved properties.

### Examples

### Definitions of Reactants

H-Dimer Fatty Acid—(generally a hydrogenated dimer formed from conventional fatty acids (molecular weight approx. 565 g/mole molecular weight)
Piperazine—piperazine (molecular weight approx. 86 g/mole)
Caprolactone—caprolactone (approx. 114 g/mole)
Sebacic acid—1,8-octane dicarboxylic acid (approx. 202 g/mole)
MPDA—4,4′-methylenebis(2-methyl cyclohexylamine), (molecular weight approx. 238.4 g/mole)
mPDA—meta-phenylenediamine (molecular weight approx. 86 g/mole)
Verstanat™ B 1186 A—blocked isocyanate 60 wt. % in Naphtha, 7.1 NCO content, aliphatic, from Evonik, blocking agent may be ε-caprolactam.
Desmodur™ 5375—4,4′-methylenedicyclohexyl diisocyanate (molecular weight approx. 262.35 g/mole available from Covestro.
Desmodur™ N3600—hexamethyldiisocyanate (HDI) trimer available from Covestro.
Trimethylol propane—trimethylol propane
DBE—a mixture of dimethyladipate, dimethylglutarate, and dimethylsuccinate;
CH₃O₂C(CH₂)ₙCO₂CH₃ (n=2,3,4) available from Sigma Aldrich.
DMC—dimethyl carbonate

### Xylene-xylene

Acetone—acetone
Butylacetate—butyl acetate

### Polyamide Synthesis

The diamine and diacid monomers are added to the reactor. The reactor is flushed with nitrogen and kept under inert atmosphere. The reactor is heated to 160° C. and kept at that temperature for 2 hours then further heated to 200° C. and maintained at that temperature for 48 hours or until the acid number in the reactor drops below 1 (mgKOH/g). Water forms during the reaction which is allowed to distill out of the reactor. The reactor is then allowed to cool to 180 other monomers are added. The reactor temperature is maintained at 180° C. for 10 hours. The final polyamide is waxy solid at room temperature with melting points close to or above 100° C.

TABLE 1
Synthesis of Polyamide

| Polyamide | 1^{st} | Parts of first | | 2^{nd} | Parts of 2^{nd} | | Parts | | Other | Parts | |
|---|---|---|---|---|---|---|---|---|---|---|---|
| sample | Diamine | g (moles) | | Diamine | g (moles) | Acid | g (moles) | | monomer | g (moles) | |
| 1 | mPDA | 202 | (1.87) | — | — | H-dimer | 658 | (1.16) | Caprolactone | 183 | (1.605) |
| | 19.4 wt. % | | | | | 63.1 wt. % | | | 17.5 wt. % | | |
| 2 | Piperazine | 449 | (5.22) | — | — | H-dimer | 658 | (1.16) | Caprolactone | 319 | (2.80) |
| | 31.4 wt. % | | | | | 46.1 wt. % | | | 22.4 wt. % | | |
| 3 | MHMDA | 248 | (1.04) | Piperazine | 10 (0.12) | Sebacic acid | 27 | (0.13) | Caprolactone | 66 | (5.80) |
| | 26.2 wt. % | | | 1.1 wt. % | | 2.9 wt. % | | | 69.9 wt. % | | |

| | | | | | | | | | | |
|---|---|---|---|---|---|---|---|---|---|---|
| 4 | Piperazine | 188 | (2.18) | — | — | H-dimer | 866 | (1.54) | — | — |
| | 17.8 wt. % | | | | | 82.2 wt. % | | | | |

### Procedure for (One Component, Baked Using Blocked Isocyanate Polyamide Coating):

The polyamide polyol was melted at 130° C. and the high boiling point solvents (DBE and butyl acetate) were added to the melt to dilute the polyol. The solution was then cooled to 60° C. and the other ingredients were added. The solution was then further cooled to room temperature. The resulting solvent-borne coating solution is a low viscosity liquid. The coating is produced by first casting a film on a substrate, then drying the film at moderate temperature (80° C.) for 10 minutes and then baking it at 150° C. for 30 minutes.

TABLE 2
Solvents for baked one component
coatings with blocked isocyanates

| | DBE | DMC | Xylene | Acetone | Butyl acetate | |
|---|---|---|---|---|---|---|
| Coating | g | g | g | g | g | Total |
| 1 | 3 | — | — | 9.06 | 4 | 16.1 |
| 2 | 6 | 17.7 | — | 4.26 | 2 | 30.0 |
| 6 | 6 | 17.7 | — | 4.26 | 2 | 30.0 |

TABLE 3
Polymer for baked one component coatings with blocked isocyanates

| | Polyamide | | | | | | |
|---|---|---|---|---|---|---|---|
| Coating | polyol | Isocyanate | g | Extender | g | DBTL | Total |
| 1 | 1 | Vestanat ™ | 19.14 | TMP | 0.638 | 0.02 | 32.0 |
| | | B1186A | | | | | |
| 2 | 2 | Desmodur ™ | 16 | TMP | 0.607 | 0.02 | 58.0 |
| | | 5275 | | | | | |
| 6 | 6 | Vestanat | 16 | TMP | 0.666 | 0.02 | 31.4 |
| | | B1186A | | | | | |

TABLE 3a
Weights and Percentage of Components in Table 3

| | Polyamide repeat | | Isocyanate | | Caprolactone | | Polyol | | Solvent | |
|---|---|---|---|---|---|---|---|---|---|---|
| Coating | units | | component | | component | | Crosslinker | | component | |
| 1 | 10.8 | g | 19.14 | g | 2.30 | g | 0.638 | g | 16.1 | g |
| | 22.6 | wt. % | 39.9 | wt. % | 4.8 | wt. % | 1.3 | wt. % | 33.3 | wt. % |
| 2 | 32.0 | g | 16 | g | 9.25 | g | 0.607 | g | 30.0 | g |
| | 36.4 | wt. % | 18.2 | wt. % | 10.5 | wt. % | 0.7 | wt. % | 34.1 | wt. % |
| 6 | 14.7 | g | 16 | g | 0 g and 0 wt. % | | 0.666 | g | 30.0 | g |
| | 24.0 | wt. % | 26.1 | wt. % | | | 1.1 | wt. % | 48.9 | wt. % |

### Procedure for Two Component (Polyamide Polyol and Polyisocyanate) Solvent-Borne Coatings:

The polyamide polyol was melted at 130° C. and the high boiling point solvents (DBE and Butyl Acetate) were added to the melt to dilute the polyol. The solution was then cooled to 60° C. and the extender and the DBTL catalyst are also added to the solution. The solution was then further cooled to room temperature. The resulting solvent-borne polyol solution is a low viscosity liquid. The coating is produced by first mixing the polyol solution component with the isocyanate component at room temperature then a film is cast on a substrate. The film was allowed to dry at room temperature 7 days before testing.

TABLE 4
Solvents for two component coatings dried 7 days at 24° C.

| | DBE | | | | | |
|---|---|---|---|---|---|---|
| Coating | g | DMC | Xylene | Acetone | Butyl acetate | Total |
| 3 | — | 55.26 | — | — | — | 55.3 |
| 4 | — | — | — | 25.56 | — | 25.6 |
| 5 | — | — | 23.06 | — | — | 23.1 |

TABLE 5
Polymer for two component coatings dried 7 days at 24° C.

| | Polyamide | Polyol amount | | | | Total |
|---|---|---|---|---|---|---|
| Coating | polyol | g | Isocyanate | g | DBTL | g |
| 3 | 1 | 117.436 | Desmodur | 27.29 | 0.03 | 144.7 |
| | | | N3600 | | | |
| 4 | 2 | 58.58 | Desmodur | 14.88 | 0.015 | 74.5 |
| | | | N3600 | | | |
| 5 | 3 | 53.8 | Desmodur | 23.13 | 0.016 | 76.9 |
| | | | N3600 | | | |

TABLE 5a
Percentage of Components in Table 5

| | Polyamide repeat | | Isocyanate | | Caprolactone | | Solvent | |
|---|---|---|---|---|---|---|---|---|
| Coating | units | | component | | component | | component | |
| 3 | 96.9 | g | 27.29 | g | 20.6 | g | 55.26 | g |
| | 48.4 | wt. % | 13.6 | wt. % | 10.3 | wt. % | 27.6 | wt. % |
| 4 | 45.5 | g | 14.88 | g | 13.12 | g | 25.56 | g |
| | 45.5 | wt. % | 14.9 | wt. % | 13.1 | wt. % | 25.6 | wt. % |
| 5 | 16.1 | g | 23.13 | g | 37.6 | g | 23.0 | g |
| | 16.1 | wt. % | 23.1 | wt. % | 37.6 | wt. % | 23.0 | wt. % |

In the following examples: hydroxyl (OH) numbers were determined using the TSI method (ASTM E1899); acid numbers were determined by titration using NaOH titrant and methylene blue indicator; and viscosities were determined by a Brookfield DV-E Viscometer using an LV spindle at 60 rpm or 30 rpm depending on how viscous the material was, as is understood by those familiar with using viscometer instruments.

Example 1 (polyamide synthesis): 750 parts of hydrogenated dimer acid were mixed with 221 parts of meta-phenylenediamine in a nitrogen atmosphere and heated to 180° C. As the monomers started to react, water formed and was allowed to evaporate from the reactor. After 48 h the acid number of the mixture was less than 1 mg KOH/g. Then 166 parts of epsilon-caprolactone were added to the reactor and reacted at 180° C. for 12 h. The resulting polyamide was a dark yellow product with an OH number of 74.5 and a melt viscosity of 25,000 cP at 100° C.

Example 2 (polyamide synthesis): 750 parts of hydrogenated dimer acid were mixed with 164 parts of piperazine in a nitrogen atmosphere and heated to 180° C. As the monomers started to react, water formed and was allowed to evaporate from the reactor. After 48 h the acid number of the mixture was less than 1 mg KOH/g. Then 134 parts of epsilon-caprolactone were added to the reactor and reacted at 180° C. for 12 h. The resulting polymer was a light yellow product with an OH number of 65.9 and a melt viscosity of 3,100 cP at 100° C.

Example 3 (polyamide synthesis): 299 parts of sebacic acid and 291.7 parts of dodecadioic acid were mixed with 465.4 parts of 250 g/mol polytetramethyleneoxide and 42.2 parts of piperazine in a nitrogen atmosphere and heated to 180° C. As the monomers started to react, water formed and was allowed to evaporate from the reactor. After 48 h the acid number of the mixture was less than 1 mg KOH/g. The resulting polymer was a light yellow product with an OH number of 65.8 and a melt viscosity of 650 cP at 100° C.

Example 4 (polyamide synthesis): 620.5 parts of hydrogenated dimer acid were mixed with 285.5 parts of isophoronediamine in a nitrogen atmosphere and heated to 180° C. As the monomers started to react, water formed and was allowed to evaporate from the reactor. After 48 h the acid number of the mixture was less than 1 mg KOH/g. Then 134 parts of epsilon-caprolactone were added to the reactor and reacted at 180° C. for 12 h. The resulting polymer was a light yellow product with an OH number of 65.9 and a melt viscosity of 19,000 cP at 100° C.

Example 5 (polyamide synthesis): 509.2 parts of hydrogenated dimer acid were mixed with 371.9 parts of 4,4′-methylenebis(2-methylcyclohexylamine) in a nitrogen atmosphere and heated to 180° C. ° C. As the monomers started to react, water formed and was allowed to evaporate from the reactor. After 48 h the acid number of the mixture was less than 1 mg KOH/g. Then 152.1 parts of epsilon-caprolactone were added to the reactor and reacted at 180° C. for 12 h. The resulting polymer was a light yellow product with an OH number of 74.5 and a melt viscosity of 15,000 cP at 100° C.

Example 6: 128 g of propylene glycol monomethyl ether acetate was combined with 10.5 g of Lubrizol Solsperse® M387 polymeric dispersant and 30 g of BASF Laropal® A81 aldehyde resin, then mixed at 500 RPM until homogenous. 392 g of Rutile titanium dioxide was added and mixed at 1500 RPM using a Cowles blade until a grind fineness of 7+ Hegman using a Hegman gauge, was obtained. 127.4 g of the polyamide of Example 1 was added along with 34.3 g of dipropyleneglycoldimethylether, 34.3 g of dimethylcarbonate, 140 g of methyl ethyl ketone, and 0.45 g of dibutyltin dilaurate, then mixed for 15 minutes at 500 RPM 98 g of Covestro Desmodur® N-3600 aliphatic polyisocyanate was added and mixed at 500 RPM for 10 minutes.

Example 7: 73 g of propylene glycol monomethyl ether acetate was combined with 6 g of Lubrizol Solsperse® M387 polymeric dispersant, 17 g of BASF Laropal® A81 aldehyde resin, and 2.5 g of BYK-052 N silicone-free defoamer, then mixed at 500 RPM until homogenous. 224 g of Rutile titanium dioxide was added and mixed at 1500 RPM using a Cowles blade until a grind fineness of 7+ Hegman using a Hegman gauge, was obtained. 320 g of the polyamide of Example 2 was added along with 96 g of methyl ethyl ketone, 96 g of 2,2,4-trimethyl-1,3-pentanediol monoisobutyrate, and 1.6 g of dibutyltin dilaurate, then mixed for 15 minutes at 500 RPM. 192 g of Covestro Desmodur® N-3600 aliphatic polyisocyanate was added and mixed for 10 minutes.

Example 8: 128 g of propylene glycol monomethyl ether acetate was combined with 10.5 g of Lubrizol Solsperse® M387 polymeric dispersant and 30 g of BASF Laropal® A81 aldehyde resin, then mixed at 500 RPM until homogenous. 392 g of Rutile titanium dioxide was added and mixed at 1500 RPM using a Cowles blade until a grind fineness of 7+ Hegman was obtained. 196 g of the polyamide of Example 3 was added along with 140 g of methyl ethyl ketone and 0.45 g of dibutyltin dilaurate, then mixed for 15 minutes at 500 RPM. 98 g of Covestro Desmodur® N-3600 aliphatic polyisocyanate was added and mixed for 10 minutes.

Example 9: 128 g of propylene glycol monomethyl ether acetate was combined with 10.5 g of Lubrizol Solsperse® M387 polymeric dispersant and 30 g of BASF Laropal® A81 aldehyde resin, then mixed at 500 RPM until homogenous. 392 g of Rutile titanium dioxide was added and mixed at 1500 RPM using a Cowles blade until a grind fineness of 7+ Hegman was obtained. 196 g of Asahi Masei Duranol® T5652 polycarbonate polyol was added along with 140 g of methyl ethyl ketone and 0.45 g of dibutyltin dilaurate, then mixed for 15 minutes at 500 RPM. 98 g of Covestro Desmodur® N-3600 aliphatic polyisocyanate was added and mixed for 10 minutes.

Example 10: 128 g of propylene glycol monomethyl ether acetate was combined with 10.5 g of Lubrizol Solsperse® M387 polymeric dispersant and 30 g of BASF Laropal® A81 aldehyde resin, then mixed at 500 RPM until homogenous. 392 g of Rutile titanium dioxide was added and mixed at 1500 RPM using a Cowles blade until a grind fineness of 7+ Hegman was obtained. 196 g of Panolam Piothane® 67-2000 HNA polyester polyol was added along with 140 g of methyl ethyl ketone and 0.45 g of dibutyltin dilaurate, then mixed for 15 minutes at 500 RPM. 98 g of Covestro Desmodur® N-3600 aliphatic polyisocyanate was added and mixed for 10 minutes.

The compositions of Examples 6 through 10 were coated onto cold rolled steel according to ASTM D523-08. In the Examples described in Table 6 below, Initial viscosity (“IV”) was determined using ASTM D4287-10, Spindle #3 at 100 RPM, average 60° gloss (“Gloss”) was determined using ASTM D523-08, average 60° haze (“Haze”) and average 60° distinctness of image (“DOI”) were determined using ASTM D4039-09, average 7 day Koenig Hardness (“Hardness”) was determined using ASTM D4366, flexibility (“Flex.”) was determined using ASTM D522-13, impact (direct/reverse) (“Impact”) was determined using ASTM D2794-93, and average 1 day wet crosshatch adhesion (“Adhesion”) was determined using ASTM D3359-17.

TABLE 6

| | Example 6 | Example 7 | Example 8 | Example 9 | Example 10 |
|---|---|---|---|---|---|
| Chemistry | Polyamide | Polyamide | Polyamide | Polycarbonate | Polyester |
| IV (cps) | 535 | 320 | 290 | 212 | 230 |
| Gloss (GU) | 108.20 | 105.70 | 29.30 | 109.10 | too sticky |
| Haze (HU) | 32.10 | 40.70 | 28.00 | 35.50 | too sticky |
| DOI | 56.20 | 49.40 | 0.60 | 97.90 | too sticky |
| Hardness (#OSC) | 98 | 23 | 23 | 58 | 1 |
| Flex. | no cracking | no cracking | no cracking | no cracking | coating came off |
| Impact (in.*lbs.) | 160/160 | 160/160 | 160/160 | 160/160 | coating came off |
| Adhesion | 0B | 0B | 0B | 0B | N/A |

Except in the Examples, or where otherwise indicated, all numerical quantities in this description specifying amounts, reaction conditions, molecular weights, number of carbon atoms, etc., are to be understood as modified by the word “about.” Unless otherwise indicated, all percent and formulation values are on a molar basis.

Unless otherwise indicated, all molecular weights are number average molecular weights. Unless otherwise indicated, each chemical or composition referred to herein should be interpreted as being a commercial grade material which may contain the isomers, by-products, derivatives, and other such materials which are normally understood to be present in the commercial grade.

As used herein, the expression “consisting essentially of” permits the inclusion of substances that do not materially affect the basic and novel characteristics of the composition under consideration. All of the embodiments of the invention described herein are contemplated from and may be read from both an open-ended and inclusive view (i.e., using “comprising of” language) and a closed and exclusive view (i.e., using “consisting of” language).

As used herein parentheses are used designate 1) that the something is optionally present such that monomer(s) means monomer or monomers or (meth)acrylate means methacrylate or acrylate, 2) to qualify or further define a previously mentioned term, or 3) to list narrower embodiments.

While certain representative embodiments and details have been shown for the purpose of illustrating the subject invention, it will be apparent to those skilled in this art that various changes and modifications can be made therein without departing from the scope of the subject invention.

1. A thermosettable composition comprising:
a) 10 to 75 wt. % of a polyamide oligomer predominantly having at least two amide linkages and two terminal end groups selected from the end groups of amine, hydroxyl or carboxylic acid end groups;
b) 10 to 50 wt. % of a di or polyisocyanate component reactive with amine, carboxylic, and/or hydroxyl groups to form covalent chemical bonds;
c) one or more non-reactive organic diluents; and
d) up to 50 wt. % of one or more compounds of less than 500 g/mole molecular weight having three or more groups reactive with isocyanates selected from the group of amine and hydroxyl groups;
wherein said thermosettable composition of a), b), c) and d) prior to reaction of said isocyanate groups with said end groups selected from amine, hydroxyl, or carboxylic acid end groups, has an average functionality of all isocyanate, amine, hydroxyl, and carboxylic acid end groups of 2.1 or more per molecule;
wherein said weight percentages are based on the total components of said thermosettable composition; and
wherein said composition prior to reaction of said di or polyisocyanate, when at or diluted to 50% solids has a viscosity at 25° C. of less than 10,000 cps measured by a Brookfield Rotating Disc viscometer, using a rotation speed of 5 rpm, and a #6 spindle.

2. The thermosettable composition of claim 1, wherein the polyamide oligomer is polyamide repeat units derived from polymerizing
a) diamines having two amine groups capable of forming covalent bonds with a carbonyl of a carboxylic acid selected from the group consisting of diamines having from 4 to 60 carbon atoms having two secondary terminal amine groups and/or diamines having from 4 to 60 carbon atoms having one or two primary amine groups, with
b) lactone and or carboxylic acid monomers, wherein the lactone or carboxylic acid units are from an acid component selected from the group consisting of C₅ to C₈ lactone, C₅ to C₈ hydroxycarboxylic acids, and aliphatic dicarboxylic acids of 4 to 50 carbon atoms, wherein said lactone and/or carboxylic acid monomers form repeat units with a carbonyl from the lactone, hydroxycarboxylic acids, and aliphatic dicarboxylic acid reacting with an primary or secondary amine nitrogen to form amide linkage and thereby forming a polyamide oligomer.

3. The thermosettable composition of claim 2, wherein at least 40 mole % of said diamines are cyclic diamines where the nitrogen atoms are in secondary amine groups and part of the one or more rings and having 4 to 15 carbon atoms.

4. The thermosettable composition of claim 2, wherein at least 50 mole % of said diamines are diamines having two primary amine groups, said diamines having two primary amine groups being of the structures

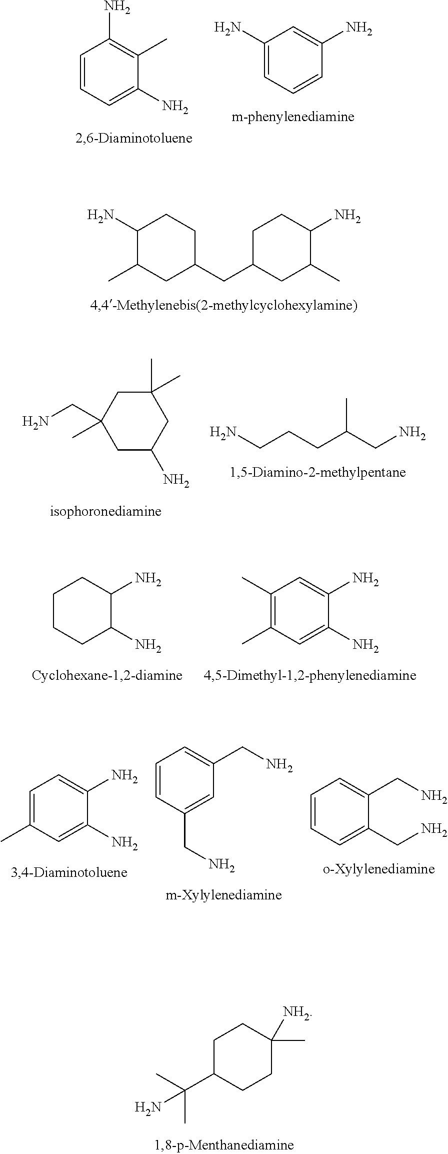

5. The thermosettable composition of claim 2, wherein the polyamide oligomer is comprised of repeat units from dicarboxylic acids reacted with amine groups wherein at least 50 mole % of said dicarboxylic acid component being in an amide repeat unit are dicarboxylic acids of 10 to 50 carbon atoms.

6. The thermosettable composition of claim 2, wherein at least 50 wt. % of the repeat units from carboxylic acids are derived from dimer fatty acids.

7. The thermosettable composition of claim 2, wherein the combined repeat units of diamine and lactone and/or carboxylic acid monomers forming at least one amide linkage during their polymerization into said polyamide are from 20 to 60 wt. % of the thermosettable composition.

8. The thermosettable composition of claim 2, wherein the combined repeat units of diamine and lactone and/or carboxylic acid monomers forming at least one amide linkage during their polymerization into said polyamide are from 25 to 50 wt. % of the thermosettable composition.

9. The thermosettable composition of claim 2, wherein at least 90 wt. % of the repeat units from diamines are derived from cyclic and/or dicyclic diamines of 4 to 15 carbon atoms, wherein the nitrogen atoms of the diamine are part of the ring structure.

10. The thermosettable composition of claim 1, wherein said reactive polyisocyanate or blocked isocyanate, combined if both are present, are present in the solution in an amount for about 10 to 50 wt. % of said solution, based on the weight of all components to said composition.

11. The thermosettable composition of claim 1, wherein said organic diluent is present from about 10 to about 50 wt. % of said composition.

12. The thermosettable composition of claim 11, wherein said organic diluent is selected from the group consisting of isopropanol, acetone, dimethyl carbonate, and butyl acetate.

13. The thermosettable composition of any one of claims 1 to 12, wherein the solution after evaporation of the solvent is thermoset.

14. The thermosettable composition of claim 1, wherein said polyisocyanate component has two or more isocyanate groups per polyisocyanate and the ratio of isocyanate groups of said polyisocyanate to combined hydroxyl, amino and/or carboxylic groups is from 2:1 to 1:1.

15. The thermosettable composition of claim 1, wherein as the organic diluent evaporates, the polyamide oligomer is crosslinked via reactions with said polyisocyanate component reactive with hydroxyl, carboxylic, and/or amino groups to form covalent chemical bonds to create a polymer of number average molecular weight of at least 1,000,000 g/mole.

16. The thermosettable composition of claim 1, formed into a self-supporting film, coating, or adhesive.

17. A method for forming a thermosettable coating or film comprising:
a) polymerizing diamines selected from the group consisting of diamines having from 4 to 60 carbon atoms and having two secondary terminal amine groups and diamines having two primary amine groups, wherein said diamines having two primary amine groups are optionally of the structures 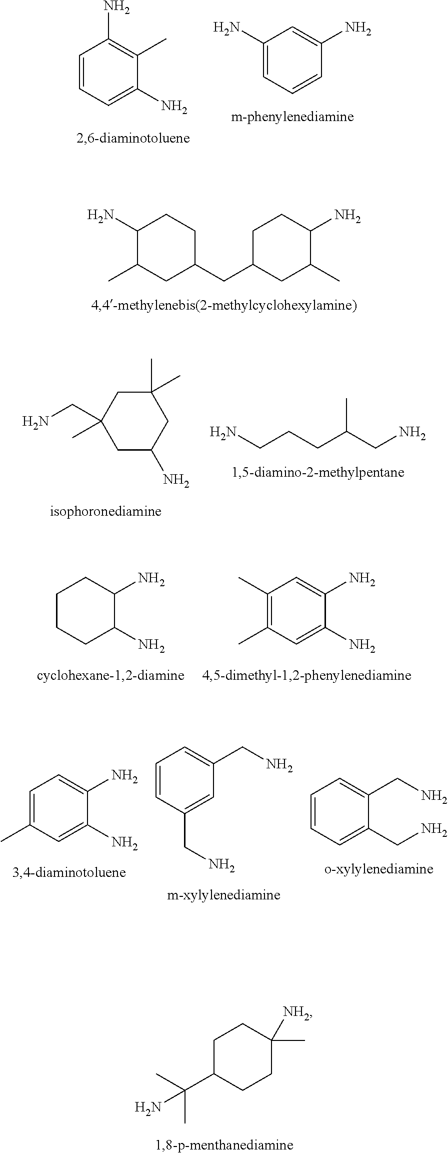
reacted with carboxylic acid groups, wherein the carboxylic acid units are from a lactone and/or carboxylic acid component selected from the group consisting of C₅ to C₈ lactone, C₅ to C₈ hydroxycarboxylic acids, and aliphatic dicarboxylic acids of 4 to 50 carbon atom; forming repeat units with a carbonyl or nitrogen as part of an amide linkage and thereby forming a polyamide oligomer; and wherein said polyamide oligomer has at least two terminal groups selected from amine, carboxylic or hydroxyl groups;
b) optionally heating said polyamide oligomer to a temperature from 100 to 150° C. to make it a more processable liquid;
c) adding one or more non-reactive organic diluents; and
d) adding to said polyamide oligomer 10 to 40 wt. % of a polyisocyanate component, optionally having blocked isocyanate group(s)) reactive with hydroxyl, carboxylic, and/or amino groups to form covalent chemical bonds with the nitrogen of said amino groups or the oxygen of said hydroxyl groups or reactions of said carboxylic groups with isocyanate, hydroxyl, or amine groups, wherein the weight percent of diamine and carboxylic acid repeating units in said solution is from 10 to 75 wt. %, the amount of organic diluent is up to 50 wt. % of said solution, and the amount of said component reactive with hydroxyl, carboxylic, and/or amino groups is from 10 to 40 wt. % of said solution and wherein said solution at 50% solids and prior to reaction of said polyisocyanate has a viscosity at 25° C. measured by a Brookfield Rotating Disc viscometer, using a rotation speed of 5 rpm, and a #6 spindle of less than 10,000 cps.

18. The method of claim 17, wherein the organic diluent is evaporated from the solution and the isocyanate groups react with the hydroxyl, carboxylic, and/or amino groups to form covalent bonds.

19. The method of claim 18, wherein at least 50 mole % of said diamine are cyclic diamines where the nitrogen atoms are secondary and part of the ring and having 4 to 15 carbon atoms.

20. The method of claim 18, wherein at least 50 mole % of said diamines are diamines having two primary amine groups, said diamines having two primary amine groups being of the structures

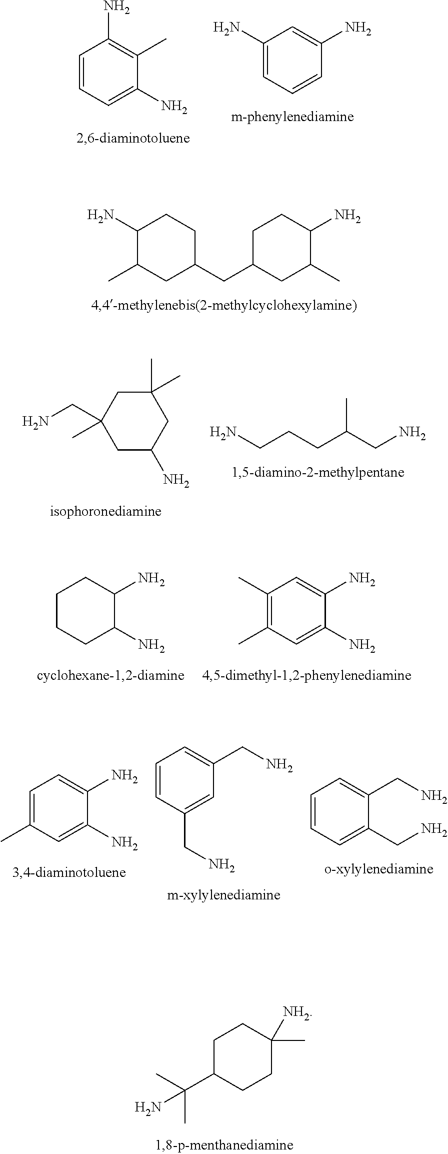

21. The method of claim 17, wherein at least 50 wt. % of the repeat units from carboxylic acids are derived from dicarboxylic acids of 10 to 50 carbon atoms.

22. The method of claim 21, wherein at least 50 wt. % of the repeat units from carboxylic acids are derived from dimer fatty acids.

23. The method of claim 17, wherein said component reactive with hydroxyl, carboxylic, and/or amino groups is a blocked polyisocyanate having two or more isocyanate groups in chemically blocked form that can be deblocked by thermal heating and said blocked polyisocyanate can be added to the polyamide oligomer without concern for a chemical reaction until such time that said blocked isocyanate groups are unblocked.

24. The method of claim 17, further including a process step where up to 25 wt. % of one or more compounds of less than 500 g/mole molecular weight having three or more groups reactive with isocyanates selected from the group of amine, carboxylic, and hydroxyl groups is added to the composition to facilitate crosslinking of the final composition.

25. The method of claim 17, wherein said polyisocyanate is not added until said composition is ready to form a coating or film and said polyisocyanate through its isocyanate groups begins to react with the polyamide oligomer upon addition of the polyisocyanate to the polyamide oligomer.
